(19) United States
(12) Patent Application Publication
(10) Pub. No.: US 2009/0207243 A1
(43) Pub. Date: Aug. 20, 2009

(54) Device for examining workpieces

(76) Inventors: Michael Kretschmer, Salzburg (AT); Gerold Staudinger, Adnet (AT); Manfred Schmidbauer, Salzburg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/990,626

(22) PCT Filed: Aug. 16, 2006
(86) PCT No.: PCT/AT2006/000341

§ 371 Date: Feb. 19, 2008

(30) Foreign Application Priority Data
Aug. 16, 2005 (AT) A 1374/2005

(51) Int. Cl. H04N 7/18; G06K 9/00

(52) U.S. Cl. 348/86; 382/141; 348/E07.085

(57) ABSTRACT

The invention relates to a device for examining workpieces (6), in particular, circuit cards, comprising an examination tool, which is clamped to the measuring head (2), which can be displaced in relation to the workpiece (6) on a workpiece plane, and also comprising an optical observation device which is used to control the measuring head (2). The optical observation device is embodied as a camera (5), which is mounted on the measuring head (2) and which comprises an optical axis (5a), such that a simple, rapid and reliable measurement can be carried out. Said axis is essentially perpendicular to the workpiece plane (6a), and a calibration device is provided in order to determine the mechanical offset (d) which is the distance of the tool (3) from the optical axis (5a) of the camera (5). The invention also relates to a method which can be carried out using the above-mentioned device.

The invention relates to a device for examining workpieces, in particular circuit cards, comprising an examination tool which is clamped in a measuring head which is movable relative to the workpiece in a workpiece plane, and comprising an optical observation device for controlling the measuring head.

In the manufacture of circuit cards or other electronic components, it is often necessary to test the quality of soldered joints. This involves examining, for example, the contacting of a microprocessor with the corresponding points on the card by introducing a tool, which is configured as a small hook, under the connecting wires and then tearing out the connecting wires with the aid of the hook. The force which is required in order to tear out the connecting wires is measured and is a measure of the quality of the soldered joint. As both the workpieces to be examined and the tool are by definition very small, the movement must be controlled with high precision, and this is therefore difficult. Similarly, a workpiece may also be examined in a non-destructive manner.

There are known devices which are referred to as bond testers and with which the above-described examinations can be carried out. In this process, a tool is arranged on a measuring head so as to be able to move relative to the workpiece in order to be able to carry out the corresponding measurements. The control is carried out by an operator who observes the workpiece and the tool via a microscope attached to the device. This operation is very highly skilled and prone to error, as the accuracy of the measurement depends substantially on whether the tool is introduced in the correct position under the corresponding wire connection. In addition, the examinations are time-consuming and therefore cost-intensive.

To date, it has not been possible to provide efficient automatic control of the measuring head in relation to the tool, as the relative position of the tip of the tool in relation to the measuring head is subject to minor changes and thus cannot be defined with the required precision. These changes are, on the one hand, due to the fact that the tool is necessarily connected to the measuring head via a force measuring device, thus inevitably producing a certain play. Furthermore, the tool is highly loaded with respect to its dimensions and can become slightly deformed during measurements, and this entails further factors of uncertainty and tolerances.

DE 199 15 052 A discloses an optical examination device for the inspection of a three-dimensional surface structure. The camera, or the optical sensor, is calibrated by a calibrating mark, allowing, for example, characteristic variables for the resolution of the optical sensor to be obtained. It is not possible to obtain information about the position of the tool.

The object of the present invention is to develop the device described hereinbefore so as to allow measuring processes to be carried out automatically, wherein an increase in positional precision makes the measurements more reliable and at the same time allows more rapid and cost-effective measurement.

A further object of the invention is to disclose a method which allows workpieces to be examined reliably, rapidly and cost-effectively.

According to the invention, these objects are achieved in that the optical observation device is embodied as a camera which is attached to the measuring head and which has an optical axis which is substantially perpendicular to the workpiece plane, and in that a calibration device is provided to determine the mechanical offset which is the distance of the tool from the optical axis of the camera.

It is fundamental to the present invention that the movement of the measuring head is controlled by a camera which is directed toward the workpiece and can thus establish the precise position of the measuring head in relation to the workpiece. A basic difference from the prior art is in this case the fact that the camera does not necessarily observe the process of engagement of the tool with the workpiece but rather serves merely for the purposes of positioning. This is crucial because high precision can be achieved only with cameras which have correspondingly small image angles and therefore high resolution, so the design conditions of the camera prevent the tool from being observed directly. Allowance is made for the position of the tip of the tool in relation to the measuring head, which changes slightly over time as a result of the above-described inaccuracies, tolerances or plastic deformations, by virtue of the fact that the measurement is preceded by a calibration in which a calibration device detects the position of the tool. As the precise relative position of the tip of the tool in relation to the camera is known once the calibration process has been carried out, the measuring head can be moved accordingly in order to achieve secure engagement of the tool.

All references hereinbefore or hereinafter to the measuring head being movable relative to the measuring head encompass both the scenario in which the workpiece is fixed and the measuring head is movable and the scenario in which the measuring head is fixed and the workpiece accordingly movable. The movement is in this case carried out in a manner known per se in the form of a table of coordinates such as is drawn up, for example, in a plotter.

A plurality of particularly preferred variations are proposed for the calibration device. A first variation is in this case embodied in such a way that the calibration device is embodied as a further camera which is movable relative to the measuring head and orientable in such a way that the tool and reference points of the measuring head can be detected by the further camera. During the calibration process, the measuring head is in this case moved in such a way that the tool enters the range of detection of the further camera. By detecting reference points which are attached to the measuring head, it is then possible to establish the position of the workpiece relative to the camera. The reference points can, for example, be attached to the lens of the camera or the lens itself is detected as a reference point. In principle, it is possible, if the further camera is embodied appropriately, to detect the tool and the reference points at the same time in order to determine the distance or the relative position. However, it is particularly preferable if the detection is carried out in succession, the tip of the tool first being brought into the optical axis of the further camera before the measuring head is moved in such a way that a reference point is also located in the optical axis of the further camera. Determining the path of travel of the measuring head allows the precise relative position to be defined. Obviously, it is also possible to position first the reference point and subsequently the tip of the tool.

An alternative calibration device is formed by a prism which is arranged at a suitable location next to the workpiece. The prism is in this case embodied in such a way that the optical axis of the camera is deflected through 180° in such a way that said camera is directed toward the tip of the tool. The known dimensions and optical properties of the prism then allow the relative position between the camera and tip of the tool to be concluded.

A further particularly beneficial variation of the present invention is characterised in that the calibration device is embodied as an opening in a receptacle for the workpiece, into which opening the tool can be introduced, and in that the camera is able optically to detect the opening. The calibration process is in this case carried out in such a way that the tip of the tool is introduced into the calibration opening as a result of corresponding movement of the measuring head, thus allowing the position of the measuring head to be established precisely. As in the method described hereinbefore, this can be carried out either simultaneously in that, once the tool has been introduced, the camera detects further reference points, the position of which relative to the calibration opening is known, and the mechanical offset can be precisely determined from this, or else, once the tip of the tool has been introduced into the calibration opening, a corresponding movement of the measuring head is carried out in a preferred manner in order to bring the calibration opening itself into the range of detection. Particularly precise calibration can be achieved if the tool has a measuring device which is embodied for controlling the movement of introduction into the calibration opening. A conical embodiment of the calibration opening is also advantageous in this regard.

In a particularly beneficial variation of the device according to the invention, provision is made for the tool to be embodied as a hook which is fastened to the measuring head via a tensile force detection device. The tensile force detection device produces in this case a signal which indicates the force which is required in order to destroy the connection to be examined.

It is particularly preferable if the workpiece plane is substantially horizontal in the use position of the device and if the tool is arranged in the measuring head so as to be able to move vertically.

Furthermore, it is particularly advantageous if the tool is arranged so as to be able to rotate in relation to the measuring head. This allows examining processes to be carried out irrespective of the orientation of the respective contacts.

With regard to the automatability of the device, it is particularly beneficial if the device is equipped with an image recognition device for automatically moving the tool. This allows, in particular, the outer shape of the electronic components, the contacting of which is to be examined, to be defined in order to ensure secure control.

Furthermore, the present invention relates to a method for examining workpieces including the following steps:
clamping a workpiece;
providing a tool on a measuring head which is mounted relative to the workpiece;
guiding the tool to the points to be examined of the workpiece, guided by an optical observation device;
performing the measurement on the points to be examined of the workpiece.

According to the invention, this method is characterised in that the tool is guided by a camera which is movable, together with the tool, relative to the workpiece and in that the position of the camera relative to the tool is detected by a calibration device. A method of this type is more rapid, more precise, more reliable and more cost-effective than known methods which are carried out using known devices.

The present invention will be described hereinafter in greater detail with reference to the exemplary embodiments illustrated in the figures, in which:

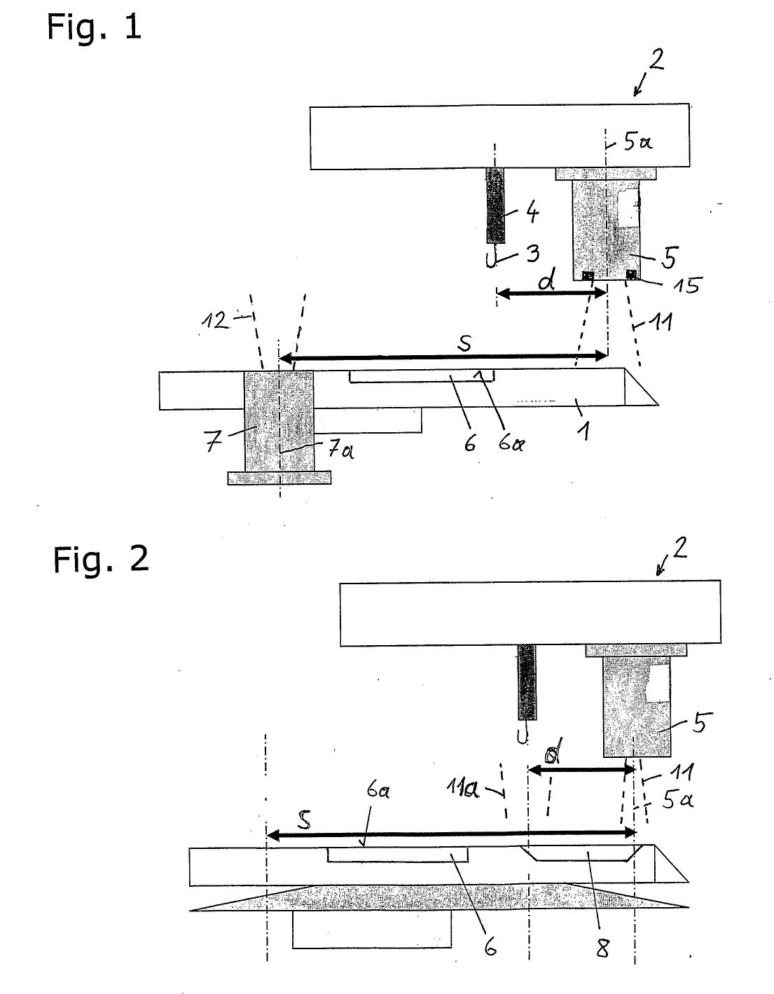

FIG. 1 is a schematic lateral view of a first variation of a device according to the invention; and

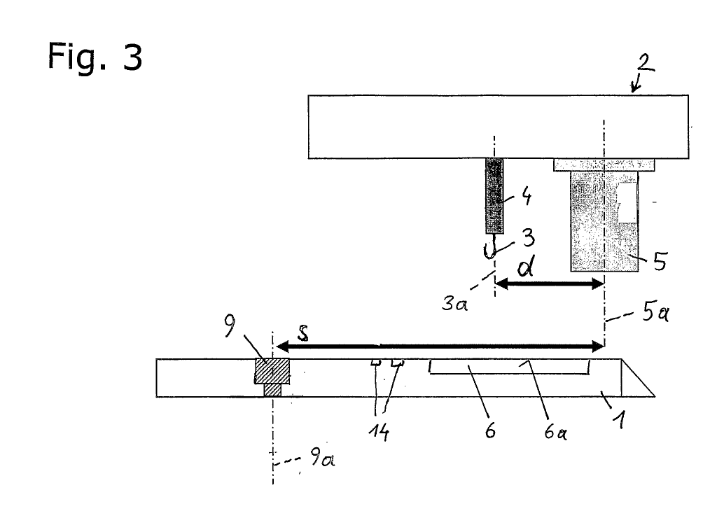

FIG. 2 and FIG. 3 are schematic views corresponding to FIG. 1 of further variations.

The device from FIG. 1 consists of a receptacle 1 for a workpiece 6 on which the measurements are to be carried out and which is arranged in a workpiece plane 6a. A tool 3, in the form of a hook, is suspended in a measuring head 2 via a tensile force detection device 4. Furthermore, a camera 5, the range of detection of which is denoted by reference numeral 11, is fastened to the measuring head 2. The mechanical offset d is defined as the distance of the axis 5a of the camera 5 from the tool 3. Fastened in the receptacle 5 is a further camera 7 having an upwardly directed detection cone 12 into which there can be introduced both the tool 3 and reference points 15 which are attached to the camera 5 and thus to the measuring head 2.

The calibration process can now be carried out in such a way that movement of the measuring head 2 causes first the tool 3 to be oriented toward the optical axis 7a of the further camera 7 before, with the aid of the reference points 15, the axis 5a of the camera 5 is brought into line with the axis 7a. This means that the optical offset s between the axes 5a, 7a is determined for the scenario in which the axis 7a of the further camera 7 is oriented toward the tool 3. In this case, the mechanical offset d and the optical offset s correspond, thus allowing the relative position between the tool 3 and optical axis 5a of the camera 5 to be determined precisely. Subsequently, the measuring head 2 is moved in such a way that the workpiece 6 is detected and the individual measuring points are identified and selected with the aid of image recognition software. Owing to the precise knowledge of the mechanical offset d, the tool 3 can now be moved precisely toward the corresponding points. When carrying out the method, it is possible after a single calibration to carry out a plurality of measuring processes, provided that it may be assumed that the mechanical offset d will remain unchanged. If it emerges that after a specific number of measuring processes or even after a single measuring process the mechanical offset d is subject to inadmissible changes, the calibration must be repeated after a corresponding number of measuring processes or, in an extreme scenario, a calibration must be carried out prior to each individual measuring process.

In the variation of FIG. 2, the calibration is carried out as a result of the fact that the camera 5 is directed toward an optical prism 8 which deflect the beams 11 of the camera 5 and, at 11a, directs them toward the tip of the tool 3.

In the variation of FIG. 3, the calibration is carried out as a result of the fact that the measuring head is moved during the calibration so as to allow the tool 3 to be lowered into a calibration opening 9. Sensors, such as for example strain gauges in the tensile force detection device 4, are used to achieve precise correspondence of the axis 9a of the calibration opening 9 with an axis 3a in which the tool 3 is arranged. In this case, the mechanical offset d can be determined as a result of the fact that the camera 5 determines the position of further reference points 14, the relative positions of which in relation to the calibration opening 9 are known. However, it is equally possible, once the tool 3 has been introduced into the calibration opening 9, to carry out a further displacement of the measuring head 2 in such a way that the axis 5a of the camera 5 is brought into line with the axis 9a of the calibration opening 9. In this case, further reference points 14 are not necessary.

The device according to the invention allows the measuring method to be carried out rapidly, reliably and precisely. Individual measured values are documented with error coding and statistically evaluated using minimum and maximum values and standard deviation Cpk and the like. Destructive tests may also be replaced by non-destructive tests in which the force with which the individual bondings are tested is limited. The tests process proceeds fully automatically and is documented using software. Furthermore, the device according to the invention has a very compact design with ergonomic and amazingly simple operability.

1. A device for examining workpieces (6), in particular circuit cards, comprising a tool (3) which can be mechanically engaged with the workpiece (6) and which is clamped in a measuring head (2) which is movable relative to the workpiece (6) in a workpiece plane, and comprising an optical observation device for controlling the measuring head (2), wherein the optical observation device is embodied as a camera (5) which is attached to the measuring head (2) and which has an optical axis (5a) which is substantially perpendicular to the workpiece plane (6a), and there is provided a calibration device which determines the mechanical offset (d) which is the distance of the tool (3) from the optical axis (5a) of the camera (5).

2. The device according to claim 1, wherein the calibration device is embodied as a further camera (7) which is movable relative to the measuring head (2) and orientable in such a way that the tool (3) and reference points (15) of the measuring head (2) can be detected by the further camera (7).

3. The device according to claim 2, wherein the optical axis (7a) of the further camera (7) is oriented parallel to the optical axis (5a) of the camera (5) which is the optical observation device.

4. The device according to claim 1, wherein the calibration device is embodied as an optical prism (8) through which the camera (5) is able to observe the tool (3).

5. The device according to claim 1, wherein the calibration device is embodied as a calibration opening (9) in a receptacle (1) for the workpiece (6), into which calibration opening (9) the tool (3) can be introduced, and the camera (5) is able optically to detect the calibration opening (9).

6. The device according to claim 5, wherein the tool (3) has a measuring device (4) which is embodied for controlling the movement of introduction into the calibration opening (9).

7. The device according to claim 6, wherein the calibration opening (9) is embodied so as to extend conically upward.

8. The device according to claim 7, wherein the tool (3) is embodied as a hook which is fastened to the measuring head (2) via a tensile force detection device (4).

9. The device according to claim 8, wherein the workpiece plane (6a) is substantially horizontal in the use position of the device and in that the tool (3) is arranged in the measuring head (2) so as to be able to move vertically.

10. The device according to claim 9, wherein the tool (3) is arranged so as to be able to rotate in relation to the measuring head (2).

11. The device according to claim 10, wherein the device is equipped with a controller based on an image recognition device for automatically moving the tool (3).

12. A method for examining workpieces (6) including the following steps:
clamping a workpiece (6);
providing a tool (3) on a measuring head (2) which is mounted relative to the workpiece (6);
guiding the tool (3) to the points to be examined of the workpiece (6), guided by an optical observation device;
performing the measurement on the points to be examined of the workpiece (6); wherein the tool (3) is guided by a camera (5) which is movable, together with the tool (3), relative to the workpiece (6) and in that the position of the camera (5) relative to the tool (3) is detected by a calibration device (7, 8, 9).

13. The method according to claim 12, wherein a calibration is carried out prior to each measurement.

14. The method according to claim 13, wherein the tool (3) is rotatably mounted and the calibration is carried out in various angular positions of the tool (3) in relation to an axis which is substantially normal to the workpiece plane (6a).

15. The method according to claim 14, wherein the calibration is carried out by a further camera (7) which is directed toward the tool (3) and toward reference points (15) of the measuring head (2).

16. The method according to claim 15, wherein the camera (5) is directed simultaneously toward the tool (3) and toward the reference points (15).

17. The Method according to claim 15, wherein the camera (5) is directed successively toward the tool (3) and toward the reference points (15) or vice versa.

18. The method according to claim 12, wherein the calibration is carried out through a prism (8) toward which the camera (5) is directed in such a way that the tool (3) is detected.

19. The method according to claim 12, wherein the calibration is carried out through a calibration opening (9) into which the tool (3) is introduced and which is detected by the camera (5).

20. The method according to claim 19, wherein the camera (5) is directed, during the introduction of the tool (3) into the calibration opening (9), toward further reference points (15) which are arranged in a predetermined position relative to the calibration opening (9).

21. The method according to claim 19, wherein the tool (3) has been introduced into the calibration opening (9), the camera (5) is oriented toward said calibration opening.

22. The method according to claim 21, wherein the measuring process is carried out automatically with the aid of an image recognition method.
